(19) United States
(12) Patent Application Publication
(10) Pub. No.: US 2017/0076558 A1
(43) Pub. Date: Mar. 16, 2017

(54) INFORMATION REGISTRATION APPARATUS AND METHOD FOR INSTRUCTING INPUT TO NON-INPUT ITEM

(71) Applicant: TOSHIBA TEC KABUSHIKI KAISHA, Tokyo (JP)

(72) Inventor: Hiroyuki Abe, Tagata Shizuoka (JP)

(21) Appl. No.: 15/245,396

(22) Filed: Aug. 24, 2016

(30) Foreign Application Priority Data
Sep. 16, 2015 (JP) 2015-183434

(51) Int. Cl. G07G 1/00; G06F 3/0481; G06Q 20/20

(52) U.S. Cl. CPC G07G 1/0027; G06Q 20/206; G07G 1/0045; G06F 3/0481

(57) ABSTRACT

An information registration apparatus comprises an information reception module configured to display an input reception screen on a display device and receive an information input to one or more of items on the input reception screen and an instruction for terminating the information input via a user interface, and an input assistance module configured to display an input screen for accepting an information input to a non-input item on the input screen to instruct the solution to the non-input item if the non-input item the input to which is determined as a requisite entry in advance presents when the information reception module receives the terminating instruction.

### CROSS-REFERENCE TO RELATED APPLICATION

This application is based upon and claims the benefit of priority from Japanese Patent Application No. 2015-183434, filed Sep. 16, 2015, the entire contents of which are incorporated herein by reference.

### FIELD

Embodiments described herein relate generally to an information registration apparatus and a method for instructing an input to a requisite entry item which is not filled.

### BACKGROUND

There is a case in which some of items included in information which is registered in an information registration apparatus are set as a requisite entry. If there is a requisite entry item that is not filled when a user finishes the input to instruct an execution of the registration, a conventional information registration apparatus displays an alert screen informing the operator of an error indicating a non-input to the requisite entry item. Then, if an operation indicating that the error is confirmed is carried out by the operator, the information registration apparatus returns to a screen at the time of instructing the execution of the registration.

As described above, in a case in which the information registration apparatus executes an operation in which it returns to the screen at the time of the registration after informing an error, the operator understands only that it is necessary to fill in the requisite entry item. However, if the user is inexperienced in operation, he or she does not know how to fill in the requisite entry item. If the information registration apparatus returns to the input screen on which a plurality of items is shown, the operator has to find the requisite entry item which is not filled, which is troublesome and thus takes much time.

### DESCRIPTION OF THE DRAWINGS

FIG. 1 is a perspective view illustrating the appearance of a POS terminal device serving as an information registration apparatus according to a first embodiment;

FIG. 2 is a block diagram illustrating the hardware structure of the POS terminal device;

FIG. 3 is a block diagram illustrating the functional components of the POS terminal device;

FIG. 4 is a diagram illustrating a commodity registration screen of an example of an input reception screen;

FIG. 5 is a diagram illustrating an example of an input screen;

FIG. 6 is a flowchart schematically illustrating the flow of a processing if a closing key is pressed;

FIG. 7 is a flowchart schematically illustrating the flow of a processing if a determination key on the input screen is pressed;

FIG. 8 is a flowchart schematically illustrating the flow of a processing if a close key on the input screen is pressed;

FIG. 9 is a diagram illustrating an example of an input screen according to a second embodiment; and

FIG. 10 is a diagram illustrating an example of the input screen.

### DETAILED DESCRIPTION

In accordance with an embodiment, an information registration apparatus includes an information reception module and an input assistance module. The information reception module displays an input reception screen on a display device and receives an information input to one or more of items on the input reception screen and an instruction for terminating the information input via a user interface. The input assistance module displays an input screen for accepting an information input to a non-input item on the input screen to instruct the solution to the non-input item if the non-input item the input to which is determined as a requisite entry in advance presents when the information reception module receives the terminating instruction.

### First Embodiment

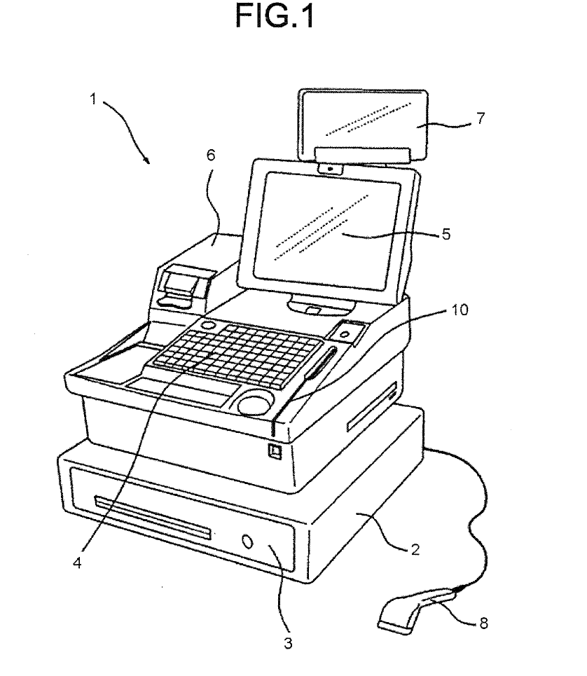

An embodiment relating to the information registration apparatus and a method for assisting an input to a requisite entry item which is not filled are described with reference to the accompanying drawings. FIG. 1 is a perspective view illustrating the appearance of a POS terminal device 1 according to the first embodiment. The POS terminal device 1 is a commodity sales data processing apparatus and also is an example of the information registration apparatus.

The POS terminal device 1 is placed on the drawer 2 to be used. The drawer 2 keeps cash including bills and coins and the like. The POS terminal device 1 controls an opening operation of a drawer casing 3 of the drawer 2. The POS terminal device 1 is equipped with a keyboard 4, a display section for operator 5, a printer 6, a display section for customer 7 and a barcode reader 8.

The keyboard 4, one of user interfaces, which is arranged at the right side of an upper surface of the POS terminal device 1, receives an operation by an operator. The keyboard 4 includes various keys such as a store clerk (sales attendant) key which is pressed to register a store clerk code (sales attendant code), numeric keys (numeric keypad) for inputting numerical values or a digit string, a cursor key and a selection determination key for selecting a predetermined item, a subtotal key for instructing the output of a total amount of commodities purchased by a customer and a closing key for declaring the closing of a transaction and the settlement.

The display section for operator 5, which is a display device (for example, a liquid crystal display device) arranged at the rear side of the keyboard 4, displays information to the operator. The printer 6, which is arranged at the left side of the upper surface of the POS terminal device 1, prints a receipt and a journal. The display section for customer 7, which is a display device (for example, a liquid crystal display device) arranged at the rear side of the display section for operator 5, displays information for the customer. The barcode reader 8 is one of the user interfaces and is connected with the POS terminal device 1 to optically read a barcode attached to a commodity (not shown) purchased by the customer.

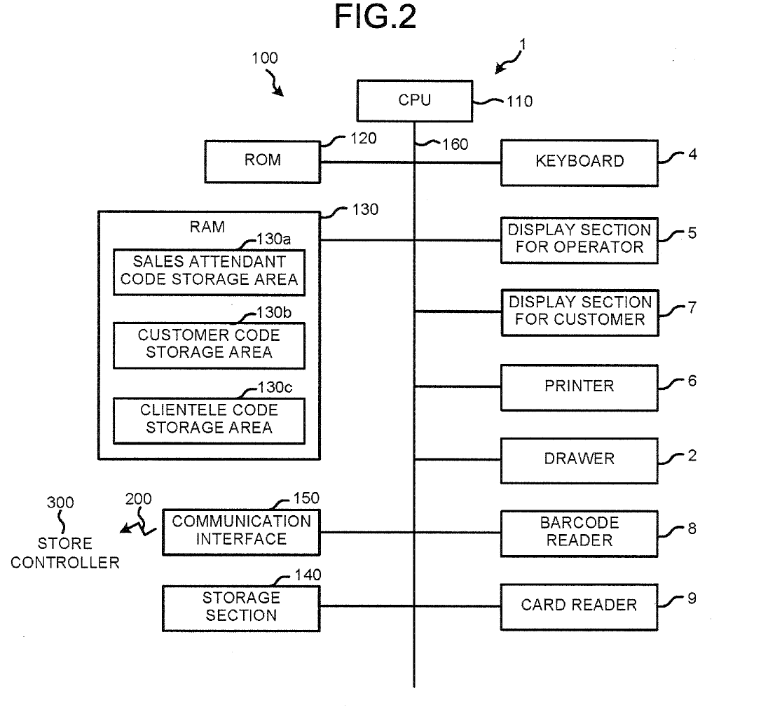

FIG. 2 is a block diagram illustrating the hardware structure of the POS terminal device 1. The POS terminal device 1 is equipped with a card reader 9, a CPU 110, a ROM 120, a RAM 130, a storage section 140, and a communication interface 150, which are connected with each other via a bus line 160.

The CPU (Central Processing Unit) 110, the ROM (Read Only Memory) 120, and the RAM (Random Access Memory) 130 constitute a control section 100.

The ROM 120 stores a fixed data (for example, program executed by the CPU 110). The RAM 130 is used as a working area for storing a variable data in a rewritable manner. The CPU 110 executes various arithmetic processing by copying or decompressing programs stored in the ROM 120 on the RAM 130 to collectively control each section of the POS terminal device 1 (the drawer 2, the keyboard 4, the display sections 5 and 7, the printer 6, the barcode reader 8, the card reader 9, the ROM 120, the RAM 130, the storage section 140 and the communication interface 150 described above).

A part of an area of the RAM 130 is used as a store clerk code (sales attendant code) storage area 130a, a customer code storage area 130b and a clientele code storage area 130c. The store clerk code (sales attendant code) storage area 130a is used to store the store clerk code (sales attendant code) serving as identification information for identifying a store clerk (sales attendant). If the store clerk (sales attendant) key is pressed, the control section 100 receives the input of the store clerk code (sales attendant code) and stores the input value or a digit string in the store clerk code (sales attendant code) storage area 130a. If a series of processing is terminated, the control section 100 erases the store clerk code (sales attendant code) in the store clerk code (sales attendant code) storage area 130a.

The customer code storage area 130b is used to store a customer code serving as identification information for identifying a customer. The customer code is recorded, for example, in a point card presented by the customer. The clientele code storage area 130c is used to store a clientele code serving as identification information for identifying a clientele. The clientele code is input by the operator through the user interface such that the operator estimates an age bracket and a gender from the appearance of the customer to determine the clientele code.

Similar to the store clerk code (sales attendant code) storage area 130a, the customer code storage area 130b (and the clientele code storage area 130c) also is controlled by the control section 100 on the data-writing and the data-erasing. If the customer (the clientele) key is pressed, the control section 100 receives the input of the customer code (the clientele code) and stores the input value or a digit string in the customer code storage area 130b (the clientele code storage area 130c). Further, if a series of processing is terminated, the control section 100 erases the customer code (the clientele code) in the customer code storage area 130b (the clientele code storage area 130c).

The RAM 130 is also used as, for example, a person in charge of operation code storage area in addition to the foregoing storage areas. The person in charge of operation code storage area stores a code of the person in charge of operation for identifying a person in charge who operates the POS terminal device 1 at the time the use of the POS terminal device 1 is started. The code of the person in charge of operation is stored in the person in charge of operation code storage area at the time the operator executes a sign-on to the POS terminal device 1. Further, the code of the person in charge of operation is erased from the person in charge of operation code storage area at the time the operator executes a sign-off to the POS terminal 1.

The card reader 9 reads information kept by a magnetic card passing through a card reading groove 10 arranged near the right side of the POS terminal device 1. The communication interface 150 mediates a data communication between a store controller 300 serving as a host device of the POS terminal device 1 and the control section 100. The communication is carried out through a local area communication network 200 arranged inside the store. Further, the communication interface 150 mediates the data communication between an external computer and the control section 100 via an Internet.

The store controller 300 is arranged at the back office of the store. In an HDD (not shown) of the store controller 300, a commodity data such as a PLU file in which the commodity code delivered to the POS terminal device 1 is associated with a price. The store controller 300 delivers the commodity data to the POS terminal device 1. The POS terminal device 1 stores the commodity data in the storage section 140.

The storage section 140 is constituted by an HDD (Hard Disk Drive) or an SSD (Solid State Drive). The storage section 140 stores an operating system (OS) and various computer programs. The operating system and various computer programs refer to programs used to realize the functions of the POS terminal device 1.

Further, the storage section 140 stores various setting values used by executing the foregoing programs. The setting values stored by the storage section 140 include, for example, an input requiring setting for determining whether or not each input item is a requisite entry item at the time a sales data is registered (described later) Furthermore, the form of the input requiring setting is not limited to that in the present embodiment, and it may be a record for determining whether or not the whole input items are a requisite entry, or a list of input items that are a requisite entry.

Further, the storage section 140 stores a sales data handled by the POS terminal device 1 in a predetermined area. The sales data is sent to the store controller 300 at, for example, a prescribed time after the business day is ended.

The POS terminal device 1 with such a configuration carries out a sales data registration processing according to an operation instruction from the operator. In the sales data registration processing, the POS terminal device 1 carries out a sales registration processing and a settlement processing.

In the sales registration processing, the POS terminal device 1 acquires the commodity code by reading the barcode with the barcode reader 8 and the price associated with the commodity code from the commodity data stored in the storage section 140 and collectively stores the data relating to one commodity the customer is going to purchase in a predetermined area on the RAM 130, temporarily.

If the subtotal key is pressed, the POS terminal device 1 starts the settlement processing. In the settlement processing, the POS terminal device 1 totals the price of each commodity temporarily stored in the predetermined area in the sales registration processing, determines the transaction in response to the press of the closing key and additionally records the total amount in the sales data in the storage section 140 as one transaction.

Next, a characteristic processing executed by the control section 100 of the POS terminal device 1 according to the computer program in the present embodiment is described. The description of the processing which is similar to the processing executed conventionally is omitted.

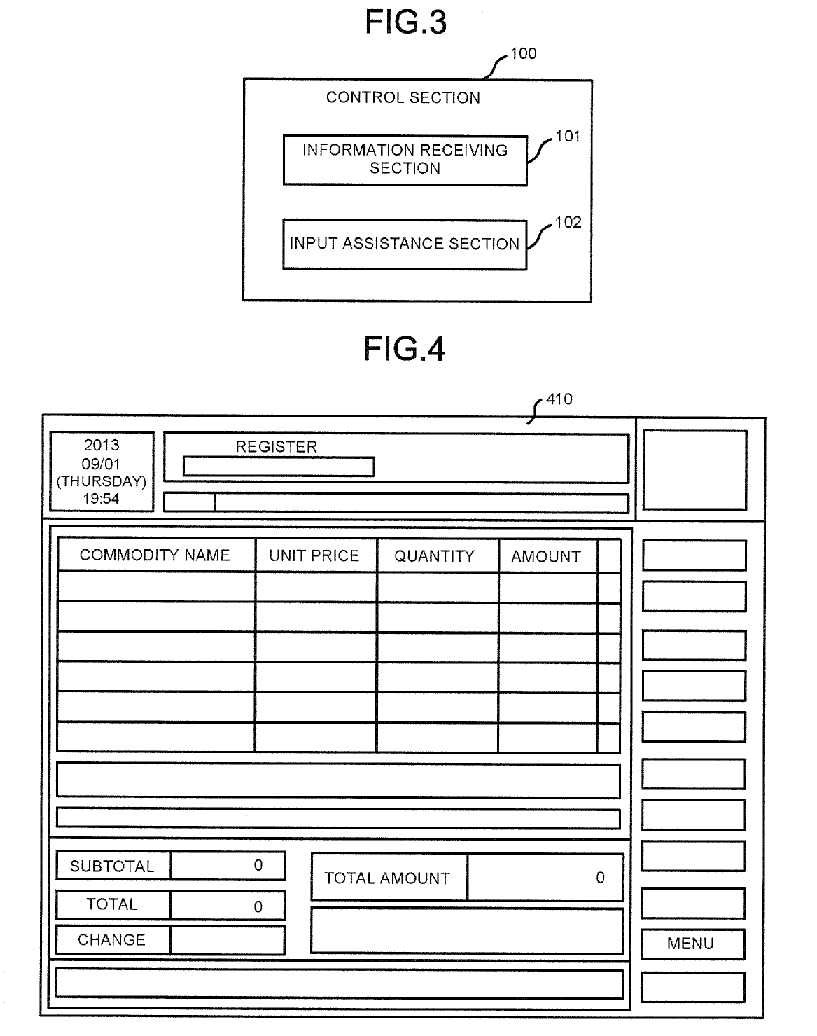

FIG. 3 is a block diagram illustrating the functional components of the POS terminal device 1. With the operation according to the computer programs, the control section 100 of the POS terminal device 1 functions as an information reception module acting as an information reception section 101 and an input assistance module acting as an input assistance section 102, as shown in FIG. 3.

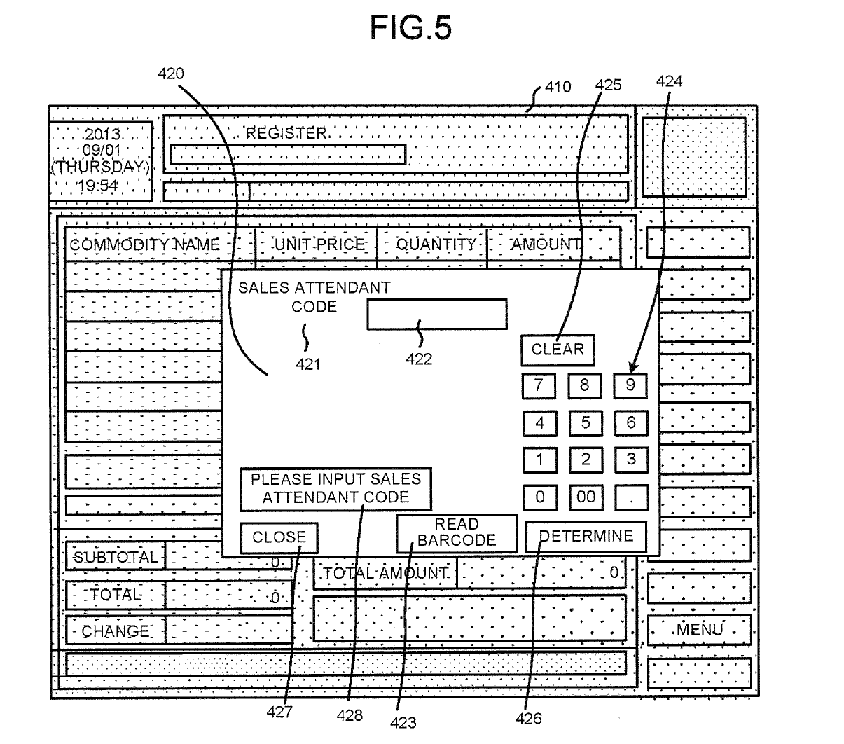

FIG. 4 is a diagram illustrating a commodity registration screen 410, i.e., an example of the input reception screen, according to the present embodiment. FIG. 5 a diagram illustrating an example of an input screen 420 according to the present embodiment. The commodity registration screen 410 and the input screen 420 are displayed by the display section for operator 5 according to the control of the control section 100.

The commodity registration screen 410 is displayed during the reception of the sales data registration of a purchased commodity brought by the customer to the POS terminal device 1. The information reception section 101 displays the commodity registration screen 410 on the display section for operator 5 and receives the sales data registration via the user interface such as the keyboard 4 or the barcode reader 8. The information reception section 101 displays the input information and the information based on the input information. The information displayed on the commodity registration screen 410 includes, for example, the commodity code read by the barcode reader 8, a commodity name and a unit price associated with the commodity code, a purchase quantity input from the keyboard 4, a discount or reduction information, an amount and the like. If the closing key on the keyboard 4 is operated, the information reception section 101 terminates the sales data registration through the commodity registration screen 410.

At the time the registration of the last purchased commodity is completed (in other words, the closing key is operated), in a case in which a problem such as the requisite entry item to which description or input is not yet performed presents, the control section 100 executes the solution of the problem prior to the settlement processing. If the requisite entry item is not filled, a processing by the input assistance section 102 is carried out.

In the present embodiment, as shown in FIG. 5, the store clerk (sales attendant) code is set to the requisite entry item, as an example. Generally, in the sales data, there are many cases in which the operator who actually operates the POS terminal device 1 is necessarily recorded, but there is also a case in which a “sales attendant” is necessarily recorded other than the operator. For example, in a case in which the store is a clothing store, there is a case in which a person in charge of customer services (sales attendant) is not the operator. In the store with such a sales form, a “sales attendant code” is set to the requisite entry item in order to keep the record of the person in charge of customer services.

It can be understood that an operator rarely forgets the input to the requisite entry item if the operator is an experienced operator, and even if rarely forgetting the input, such an operator can solve the non-input with a regular input method according to the conventional error display without being puzzled. However, as there are many cases in which an operator who tends to forget the input to the requisite entry item is an inexperienced operator, if only the error is displayed, it takes much time and effort to solve the non-input. As the shift of personnel is frequent at the sales data registration practice, it is desired that the user interface can supply assistance so that the inexperienced operator is not puzzled.

If there is a requisite entry item that is not filled up (hereinafter, referred to as a non-input item) at the time the closing key is operated, the input assistance section 102 displays a name or title 421 of the non-input item and a new input column 422 on the new input screen 420 other than the commodity registration screen 410. In this way, the input to the non-input item is instructed.

In the present embodiment, the input screen 420 is set in a pop-up manner and is displayed in a state in which it is smaller in size than the commodity registration screen 410 by being overlaid on the commodity registration screen 410. However, upon the realization, the input screen 420 may be displayed in a full size.

In the present embodiment, the input screen 420 is separated from the registration reception screen 410. However, upon the realization, the input screen 420 may be not separated from the registration reception screen 410. For example, the input screen 420 may be displayed in a state in which the input screen 420 is fitted into a part of the registration reception screen 410.

The input screen 420 includes a barcode reading key 423, numeric keys 424, a clear key 425, a determination key 426, a close key 427 and a message 428 in addition to the input column 422. The input column 422 displays the values or a digit string the input of which is received. The barcode reading key 423 is used to receive the instruction for setting the value read by the barcode reader 8 to the input value. The numeric keys 424 are used to receive the input of numerical values or a digit string. The clear key 425 is used to receive an instruction for erasing the numerical value or the digit string which is being input. The determination key 426 is used to receive an instruction for determining the value or digit storing input to the input column 422 as the value or digit storing of the non-input item (for example, sales attendant code). The close key 427 is used to receive an instruction for closing the input screen 420 regardless of the presence or absence of the input and for returning to the processing before the closing key is pressed. The message 428 informs the operator of a request through the input screen 420.

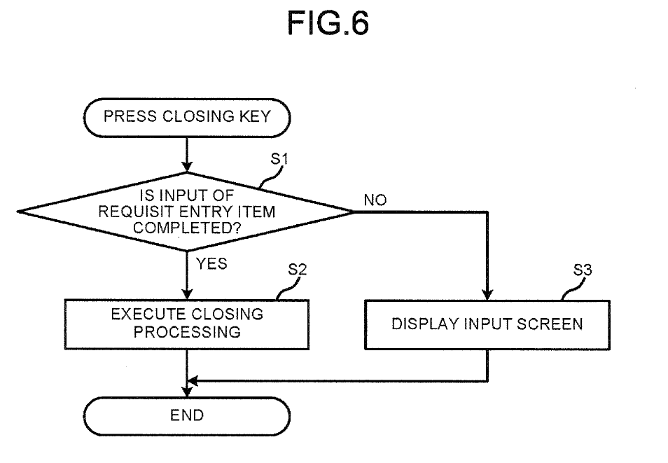

In such a configuration, the control section 100 carries out the processing shown in the flowcharts in FIG. 6-FIG. 8.

FIG. 6 is a flowchart schematically illustrating the flow of a processing executed in a case in which the closing key is pressed. If the closing key on the keyboard 4 is pressed in the sales data registration processing, the control section 100 refers to the input requiring setting stored in the storage section 140 to determine whether or not the input of all the items the input to which is necessary (requisite entry items) among the input items is completed (Act S1).

In Act S1, if the input to the requisite entry items is completed (Yes in Act S1), the control section 100 executes a closing processing (Act S2), and terminates the present processing. Contrarily, in Act S1, if input to one or more of the requisite entry items is not completed (No in Act S1), the control section 100 displays the input screen 420 (Act S3).

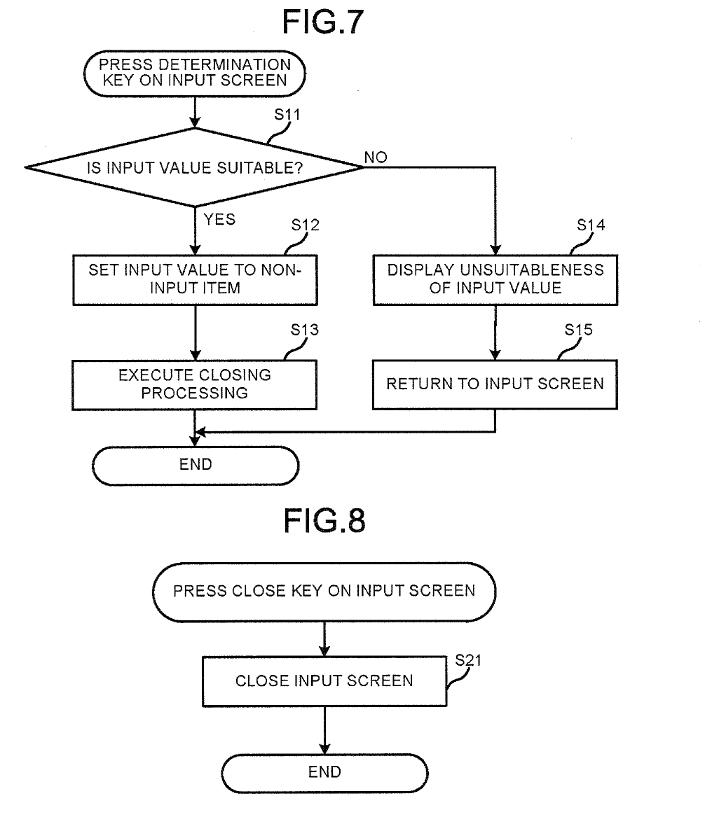

FIG. 7 is a flowchart schematically illustrating the flow of a processing executed in a case in which the determination key 426 on the input screen 420 is pressed. If the determination key 426 on the input screen 420 is pressed, the control section 100 determines whether or not the value (digit string) input into the input column 422 is suitable (Act S11). Whether the input value is suitable is determined according to whether or not the number of digits of the input numeral values matches with the specified number of digits, for example.

In Act S11, if the input value is suitable (Yes in Act S11), the control section 100 sets the input value to the non-input item (Act S12). After the closing processing is executed (Act 513), the control section 100 terminates the present processing. Contrarily, in Act S11, if the input value is not suitable (No in Act S11), the unsuitableness of the input value is informed to the operator through the screen display (Act S14), and then the control section 100 returns to the input screen 420 (Act S15).

FIG. 8 is a flowchart schematically illustrating the flow of a processing executed in a case in which the close key 427 on the input screen 420 is pressed. If the close key 427 on the input screen 420 is pressed, the control section 100 closes the input screen 420 regardless of the presence or absence of the input (Act S21), and terminates the present processing. In this way, the control section 100 returns to the processing which is executed before the closing key is pressed.

As stated above, according to the present embodiment, if there is a non-input to the requisite entry item, not the alert screen for only informing an error but the input screen 420 serving as a dedicated screen for solving the non-input is displayed to accept the input to the non-input item through the input screen 420. Thus, even the inexperienced operator can solve the non-input problem without being puzzled.

In the foregoing embodiment, a case in which the non-input item is the sales attendant code item is described as an example, if there is a plurality of the non-input items, the input screens 420 respectively containing the name or title 421 of the non-input item and the input column 422 may be displayed sequentially. In other words, for example, if there are two non-input items, a method is adopted such that the input screen 420 relating to one of the non-input items is displayed first, and then the input screen 420 relating to the remaining non-input item is displayed if the non-input of the one of the items is solved.

### Second Embodiment

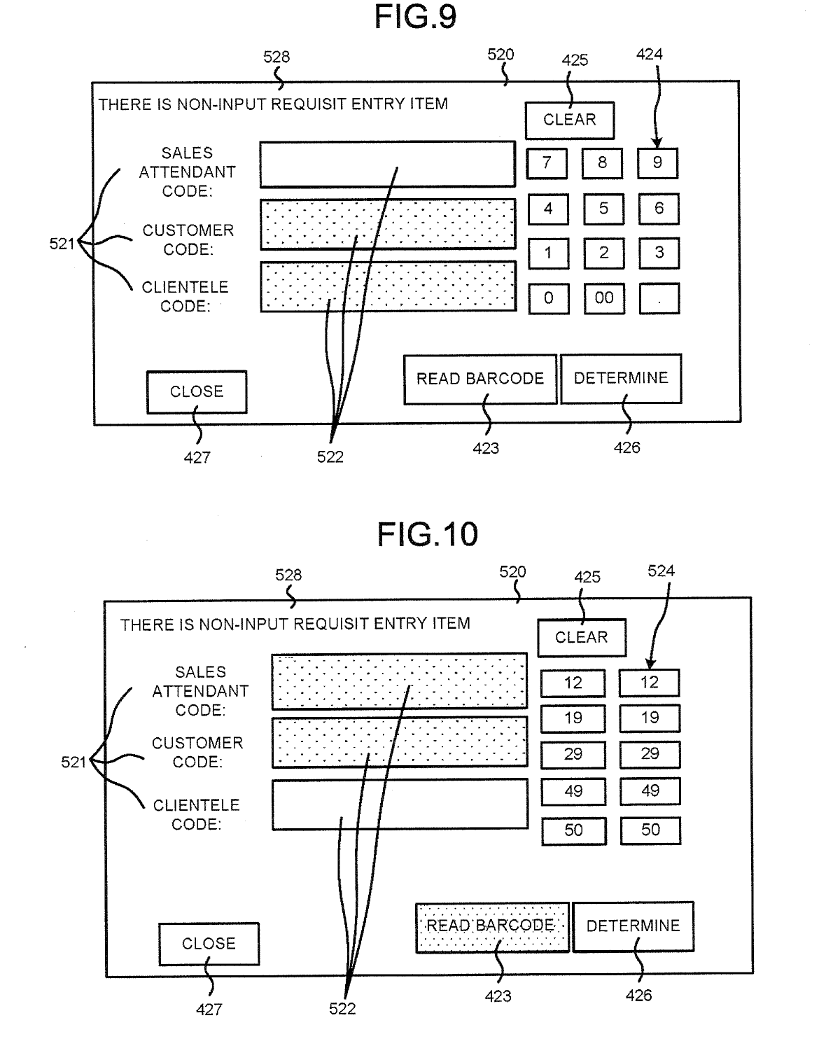

Hereinafter, the second embodiment is described. The present embodiment is a modification of the first embodiment. Upon the description of the present embodiment, the description similar to that of the first embodiment is omitted, but only the description different from the first embodiment is described. In the present embodiment, the same reference numerals are applied to the part similar to that in the first embodiment. FIG. 9 and FIG. 10 are diagrams illustrating examples of an input screen 520 according to the second embodiment.

The input screen 520 of the present embodiment, which corresponds to a plurality of the non-input items, displays a plurality of names or titles 521 of the non-input items (three, in the examples shown in FIG. 9 and FIG. 10) and includes input columns 522 for all the names or titles 521. The input column 522 and the keys displayed in a hatching pattern are invalid. In other words, the state shown in FIG. 9 indicates that the input of the sales attendant code is being currently accepted, and the state shown in FIG. 10 indicates that the input of the clientele code is being currently accepted.

At the time of inputting the sales attendant code and the customer code, the reading by the barcode reader 8 is started by pressing the barcode reading key 423, or the input of the numerical values or the digit strings by the numeric keys 424 is accepted.

At the time of inputting the clientele code, the input by a clientele key 524 is accepted. In the present embodiment, at the time of inputting the clientele code, i.e., one of the non-input items, the input assistance section 102 displays the clientele key 524 on the input screen 520 instead of the numeric keys 424. The clientele key 524 is composed of keys' for each age bracket by gender.

Through the above, according to the present embodiment, it is possible for the operator to recognize number of the non-input items at the time the input screen 520 is displayed.

According to the first and the second embodiments described above, even the inexperienced operator can solve the non-input problem without being puzzled. As a conventional manner, if only an error display for informing that the non-input item remains is displayed, it is difficult for the inexperienced operator to solve the non-input problem and thus the smooth solution to the non-input problem cannot be achieved. However, as described in the foregoing embodiments, the input screens 420 and 520 dedicated to the solution to the non-input problem are displayed and the input to the non-input item is accepted therethrough, and thus, even the inexperienced operator can solve the problem smoothly.

In the foregoing embodiments, the POS terminal device 1 is described as an example of the information registration apparatus. However, upon the implementation, the information registration apparatus is not limited to the POS terminal device, but other information registration apparatuses may be applied to the foregoing embodiments. In other words, if non-input to the requisite entry item presents at the time of registering plural information in an apparatus which registers various kinds of information, the solution to the problem can be achieved by displaying a screen for accepting the input to the non-input item.

The program executed by the information registration apparatus of the foregoing embodiment is provided by being installed in a ROM or the like in advance.

The program executed by the information registration apparatus of the present embodiment is recorded in a computer-readable recording medium such as a CD-ROM, a FD (Flexible Disk), a CD-R, a DVD (Digital Versatile Disk) or the like in the form of installable or executable file to be supplied.

Further, the program executed by the information registration apparatus of the present embodiment may be stored in a computer connected to a network such as an internet or the like, and be provided by being downloaded via the network. Furthermore, the program executed by the information registration apparatus of the present embodiment may be provided or distributed via the network such as the internet or the like.

The program executed by the information registration apparatus of the present embodiment has a module configuration including the above-described each section (the information reception section and the input assistance section). The CPU (processor) reads the program from the storage medium to execute it to load each section described above on a main storage device. In this way, the information reception section and the input assistance section are generated on the main storage device.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information registration apparatus with a display device, comprising:
an information reception module configured to display an input reception screen on the display device and receive information input to one or more of items on the input reception screen and an instruction for terminating the information input via a user interface; and
an input assistance module configured to display an input screen for accepting an information input to a non-input item on the input screen to instruct the solution to the non-input item if the non-input item the input to which is determined as a requisite entry in advance presents when the information reception module receives the terminating instruction.

2. The information registration apparatus according to claim 1, wherein the input assistance module displays the input screen in a pop-up manner on a screen that is being displayed other than the input reception screen.

3. The information registration apparatus according to claim 2, wherein the input assistance module sequentially displays the input screens for each non-input item if a plurality of the non-input items presents.

4. The information registration apparatus according to claim 2, wherein the input assistance module accepts the information input to all the non-input items on the input screen displayed if a plurality of the non-input items presents.

5. The information registration apparatus according to claim 1, wherein the input assistance module includes numeric keys on the input screen to carry out the information input to the non-input item.

6. A method for instructing an input to a non-input item, including:
displaying an input reception screen including one or more of input items;
receiving an information input to the one or more of input items on the input reception screen;
instructing a termination of the information input; and
displaying an input screen for accepting an information input to a non-input item on the input screen to instruct the solution to the non-input item if the non-input item the input to which is determined as a requisite entry in advance presents when the termination instruction is received.
